(19) United States
(12) Patent Application Publication
(10) Pub. No.: US 2025/0059880 A1
(43) Pub. Date: Feb. 20, 2025

(54) DEVICES, SYSTEMS, AND METHODS FOR ALIGNING DRILL RIGS

(71) Applicant: VERACIO LTD, Salt Lake City, UT (US)

(72) Inventors: Michael Case, Milton (CA); Geoff Moroney, Ellenbrook (AU); Adam Tomaszewski, Mississauga (CA)

(21) Appl. No.: 18/721,488

(22) PCT Filed: Dec. 20, 2022
(86) PCT No.: PCT/US2022/053480

§ 371 Date: Jun. 18, 2024

Related U.S. Application Data
(60) Provisional application No. 63/291,582, filed on Dec. 20, 2021.

(51) Int. Cl. E21B 47/024; E21B 19/24; G08B 21/18

(52) U.S. Cl. CPC E21B 47/024; E21B 19/24; G08B 21/18

(57) ABSTRACT

An alignment device for measuring orientation of a drill rig having a chuck is disclosed. The device can comprise a tubular housing having a cylindrical outer surface and defining an inner bore. The tubular housing can be configured to be receivable into the chuck of the drill rig. A gyroscopic orientation sensor can be disposed within the tubular housing. The gyroscopic orientation sensor can be configured to provide a signal indicative of an orientation of the alignment device. A wireless transmitter can be in communication with the gyroscopic orientation sensor. The wireless transmitter can be configured to transmit a wireless output indicative of the orientation of the alignment device.

### CROSS-REFERENCE TO RELATED APPLICATION

This application claims priority to and the benefit of the filing date of U.S. Provisional Patent Application No. 63/291,582, filed December 20, 201, which is incorporated herein by reference in its entirety.

### FIELD

The present disclosure relates to drill rig alignment and, in particular, to devices, systems, and methods that can be used to align a drill rig.

### BACKGROUND

Drill rigs, such as those used in underground mining, require alignment in order to orient the drill rig to drill toward a target drilling location. In particular, the azimuth of the drill rig can be difficult to determine. Magnetic compasses can be used, but they lack sufficient accuracy and can be subject to magnetic interference from equipment or surrounding ore. To provide improved accuracy, surveyors can assist with the drill rig alignment. However, surveying is an expensive and time intensive process.

Some alignment devices are coupled to an exterior of a drill rod that is held in the chuck of the drill rig. However, these devices are subject to error from the clamping means causing the devices to be offset from the axes of the drill rod. Further, an operator must be present to perform the clamping, which can be undesirable.

### SUMMARY

Described herein, in various aspects, is an alignment device for measuring orientation of a drill rig, the drill rig having a drill string component gripping assembly. The device can comprise a tubular housing having a cylindrical outer surface and defining an inner bore. The tubular housing can be configured to be receivable into the chuck of the drill rig. A gyroscopic orientation sensor can be disposed within the tubular housing. The gyroscopic orientation sensor can be configured to provide a signal indicative of an orientation of the alignment device. A wireless transmitter can be in communication with the gyroscopic orientation sensor. The wireless transmitter can be configured to transmit a wireless output indicative of the orientation of the alignment device.

In one aspect, a method can comprise gripping the alignment device with a chuck or a foot clamp of a drill rig, the drill rig having a drilling axis. The gyroscopic orientation sensor of the alignment device can be used to provide a signal indicative of an orientation of the alignment device.

In one aspect, a method can comprise coupling the alignment device to a casing of a borehole and providing, using the gyroscopic orientation sensor of the alignment device, a signal indicative of an orientation of the alignment device.

In one aspect, a system can comprise an alignment device and a remote computing device in communication with the alignment device.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a perspective view of an alignment device in accordance with embodiments disclosed herein.

FIG. 2 is an exploded view of the alignment device of FIG. 1.

FIG. 3 is a block diagram of the alignment device of FIG. 1.

FIG. 4 is a perspective view of the alignment device of FIG. 1 gripped within a chuck of a drill rig.

FIG. 5 is a perspective view of a rod handling device gripping the alignment device as in FIG. 1.

FIG. 6 is a side view of an underground drill rig drilling into a formation, in accordance with embodiments disclosed herein.

FIG. 7 is a rear perspective view of an exemplary underground drilling system comprising a drilling rig of FIG. 1.

FIG. 8 is a computing system comprising a computing device as disclosed herein.

FIG. 9 is a cut away perspective view of an alignment device as disclosed herein.

FIG. 10 is an exploded view of the alignment device of FIG. 9.

FIG. 11 shows a plurality of views of a portion of a carriage of the alignment device of FIG. 9.

FIG. 12 shows a plurality of view of a housing of the alignment device of FIG. 9.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “an indicator” can refer to one or more of such indicators, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

The word “or” as used herein can mean any one member of a particular list and, except where the context indicates otherwise, can, in alternative aspects, also include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

### Rig Alignment Device

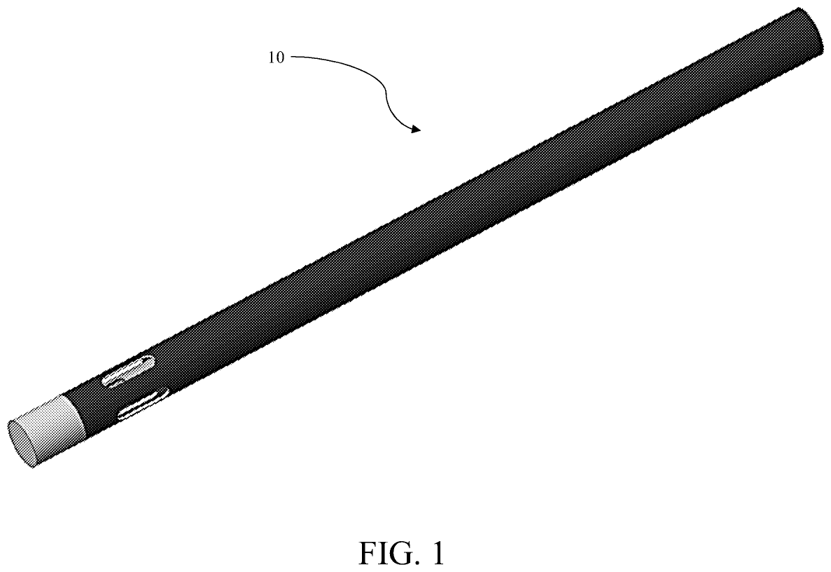

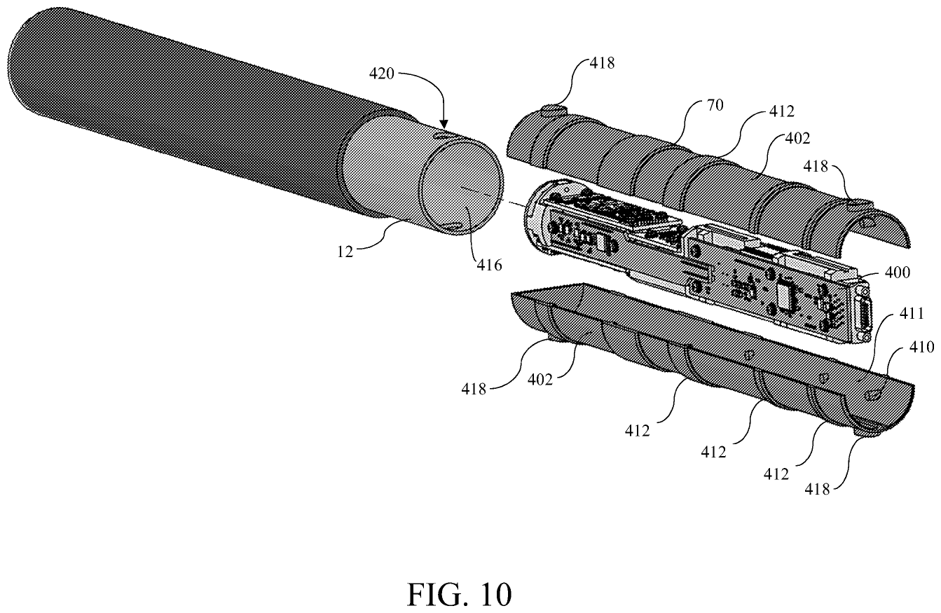

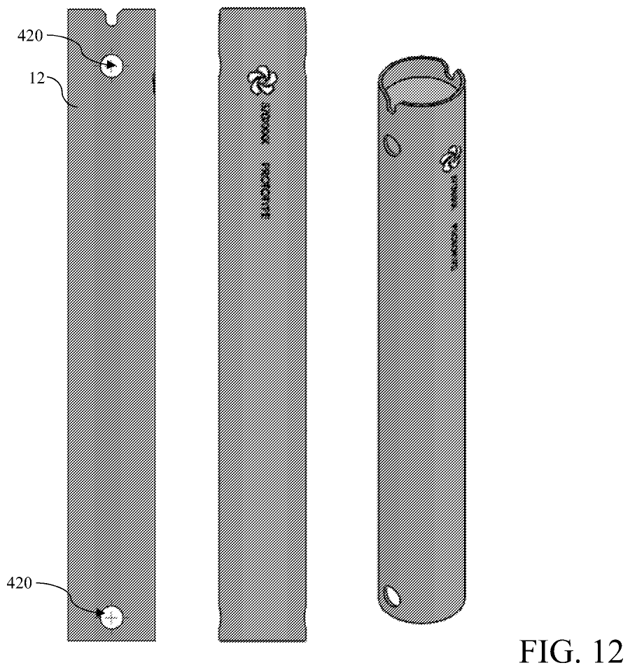

Disclosed herein and with reference to FIGS. 1-5 is an alignment device 10 for aligning a drill rig. The alignment device 10 can comprise a tubular housing 12 having a longitudinal axis 14 and a first end 16 and a second end 18 that are spaced along the longitudinal axis. Optionally, respective end caps 26 can cover each end of the tubular housing 12 to seal the internal components from the surrounding environment. The tubular housing 12 can have an outer surface 20 and can define an inner bore 22. In some aspects, outer surface 20 can be cylindrical. In further aspects, the outer surface 20 can have polygonal cross sections. For example, in various aspects, the outer surface 20 can have triangular or hexagonal cross sections. Thus, although described herein as a “tubular housing,” it is understood that the tubular housing need not have a circular or ovoid cross-section. The tubular housing 12 can optionally have the same outer diameter as a drill rod, thereby ensuring compatibility with drill rod chuck dimensions as further disclosed herein. In some optional aspects, the tubular housing 12 can comprise a modified drill rod. Optionally, the outer surface of the tubular housing can have a major cross-sectional dimension (e.g., diameter) of about 1-¾ inches, or less than 2.5 inches, or less than 2 inches, or from about 1.5 inches to about 2.5 inches. In further optional aspects, it is contemplated that a circle that inscribes the cross section of the outer circumference can have a diameter that is less than a maximum gripping diameter of a drill string component gripping assembly (e.g., a chuck or foot clamp). It is contemplated that the tubular housing 12 can be configured for use with multiple drill rigs configured for different drill rod sizes. The tubular housing 12 can be configured for handling the smallest drill string components. In this way, the tubular housing can be configured for universal use across different systems that use both large and small drill string components. In optional aspects, the inner bore 22 can be cylindrical. In further optional aspects, the inner bore 22 can have any suitable cross sectional shape. In exemplary aspects, the tubular housing 12 can comprise a metal tube, as shown in FIGS. 10 and 12.

A gyroscopic orientation sensor 30 can be disposed within the tubular housing 12. In exemplary aspects, the gyroscopic orientation sensor 30 can be or comprise a microchip-packaged gyroscope (e.g., a microchip-packaged MEMS gyroscope). However, it is contemplated that any gyroscope and/or orientation sensing components that are capable of providing signals of the type disclosed herein can be used. The gyroscopic orientation sensor 30 can be configured to provide a signal indicative of an orientation of the alignment device. In some aspects, the orientation of the alignment device can comprise an azimuth. Thus, in these aspects, it is contemplated that the signal provided by the gyroscopic orientation sensor 30 can be indicative of an azimuth of the alignment device. As used herein, it should be understood that a gyroscopic orientation sensor can comprise one or a plurality of orientation sensing components that cooperate to generate one or more signals indicative of the orientation of the alignment device. In further aspects, the alignment device can comprise a plurality of gyroscopic orientation sensors 30.

In some optional aspects, the gyroscopic orientation sensor 30 can be provided on an integrated circuit 400. In some optional aspects, the gyroscopic orientation sensor 30 (and the associated integrated circuit 400) can be housed within an inner housing (e.g., enclosure) that is received within the tubular housing. Optionally, the inner housing can comprise one or more polymer materials. In exemplary aspects, the inner housing can be, for example, a clamshell (e.g., a rubber clamshell) that protects the internal components from environmental elements.

In some aspects, the alignment device 10 can be further configured to measure dip angle with respect to gravity. For example, the alignment device 10 can comprise one or more additional sensors, such as, for example, an accelerometer or other sensor (e.g., other inertial sensor(s)) for measuring dip angle (e.g., an angle between a drilling axis and a horizontal plane). The alignment device 10 can further comprise a temperature sensor. It is contemplated that measured temperature can be used to calibrate outputs of other sensors that vary with temperature. In some optional aspects, the alignment device 10 can comprise a global positioning system (GPS) tracker that can provide an output indicative of GPS coordinates. In further aspects, the alignment device 10 can further comprise a humidity sensor.

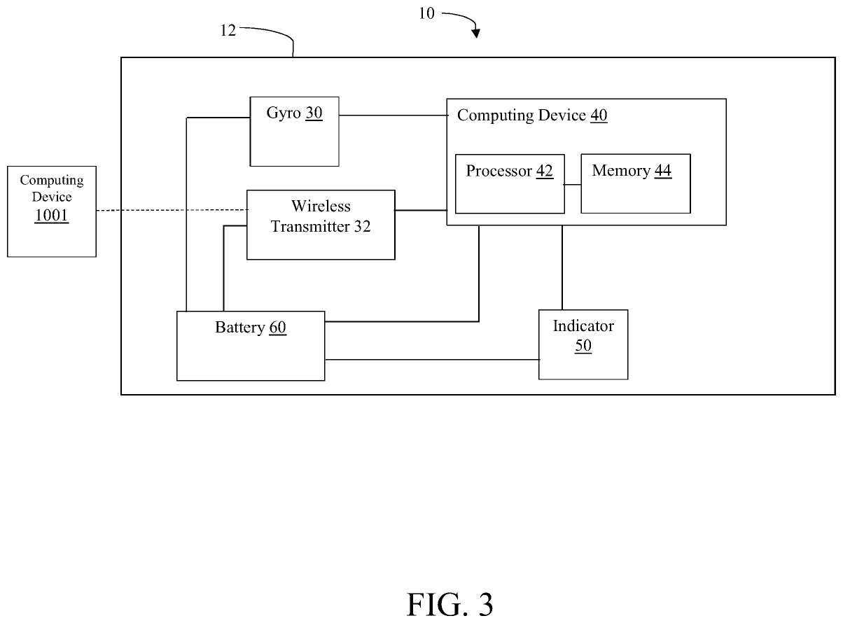

As shown in FIG. 3, a wireless transmitter 32 can be in communication with (e.g., via direct or indirect, wired or wireless, connection) the gyroscopic orientation sensor 30. The wireless transmitter 32 can be configured to transmit a wireless output indicative of the orientation of the alignment device 10. It is contemplated that the tubular housing 12 can comprise one or more windows 34 that enable wireless communication therethrough. Accordingly, it is contemplated that the one or more windows 34 can be aligned with the wireless transmitter 32 at a particular location along the longitudinal axis 14 (such that an alignment axis can intersect the windows 34 and the wireless transmitter 32. Optionally, the tubular housing 12 can define a plurality of windows 34 that are circumferentially spaced around the tubular housing 12. In these aspects, the windows 34 can optionally be equally circumferentially spaced around the tubular housing 12. The windows can, in various optional aspects, be elongate relative to the longitudinal axis 14.

In some aspects, it is contemplated that the transmitter 32 can transmit a wireless output, corresponding to the signal of the sensor, to a remote computing device 1001. In some optional aspects, the wireless output can be, for example, infrared (IR) frequency, radio frequency (e.g., Bluetooth or Wi-Fi,), or any other suitable wireless communication. In some aspects, the remote computing device 1001 can receive the wireless output from the transmitter 32 and process the signal to determine the orientation of the alignment device 10. In still further aspects, the transmitter 32 can comprise a wired transmitter such as, for example, a communication port (e.g. optionally, a RS-232 or universal serial bus port).

In further optional aspects, the alignment device 10 can have an integral computing device that processes the signal from the sensor and determines the orientation of the alignment device. In these aspects, the alignment device can optionally transmit an orientation, such as, for example, an azimuthal angle (i.e., an angle representing the azimuth associated with an orientation of the alignment device), rather than a raw signal that requires further processing by the remote computing device 1001. For example, with reference to FIG. 3, the alignment device 10 can comprise a computing device 40 comprising at least one processor 42 and a memory 44 in communication with the at least one processor. Optionally, it is contemplated that the computing device 40 can be configured in accordance with the configuration and architecture of the computing device 1001, further disclosed herein. However, it is contemplated that any computing device 40 having processing capabilities as disclosed herein can be used. The computing device 40 can be configured to receive the signal from the sensor and determine, based on the signal, the orientation of the device.

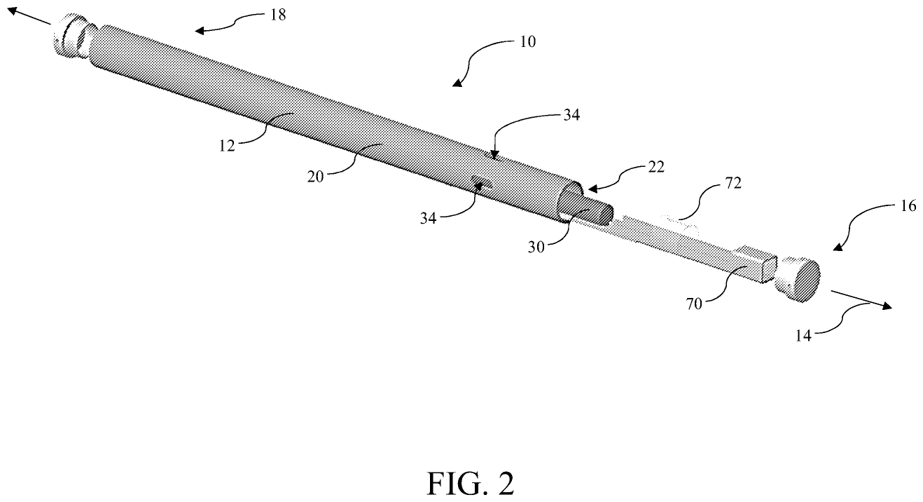

As shown in FIG. 2, the alignment device 10 can comprise an electronics cradle 70 for securing the internal components (e.g., gyroscopic orientation sensor 30, communication system, such as, for example, the wireless transmitter 32, battery, battery management system, etc.). The alignment device can further comprise a window 72 that provides for communication of wireless signals (e.g., infrared, radio frequency, etc.). The window 72 can seal against the tubular housing 12 to inhibit communication of environmental elements through the windows 34.

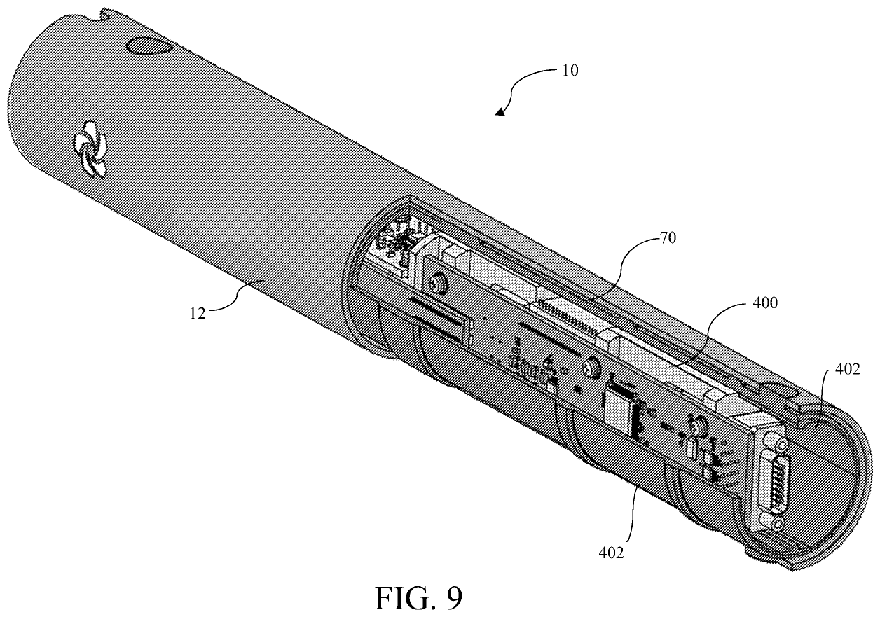

Referring to FIGS. 9-12, the cradle 70 can comprise a plurality of sections 402. For example, the cradle 70 can comprise a pair of sections 402 that are half-cylindrical and assemble together in a clamshell.

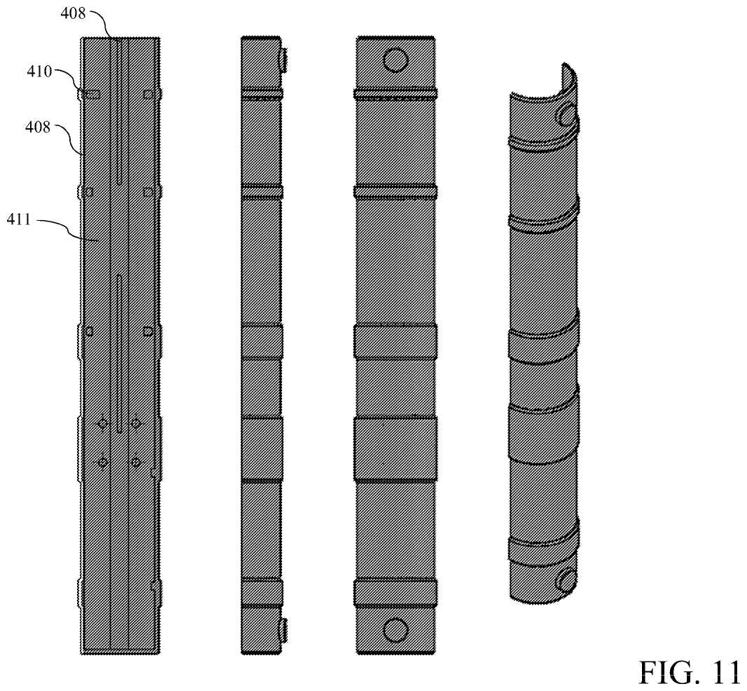

With reference to FIGS. 10-11, the cradle 70 can supportably receive the integrated circuit 400. For example, the cradle 70 can define one or more grooves 408 that receive portions (e.g., edges) of the integrated circuit 400. A plurality of inwardly extending projections 410 can extend from inner circumferential surfaces 411 of the cradle 70 to support the integrated circuit 400.

The cradle 70 can comprise, or be formed from, a flexible material to allow the cradle to compress to absorb shock and vibrations. The flexible material can be, for example, silicone rubber, foam, or other flexible polymer. In this way, the cradle 70 can isolate the integrated circuit 400 and the gyroscopic orientation sensor 30 from shock and vibrations. It is contemplated that the vibration isolation can improve accuracy of the gyroscopic orientation sensor 30 as well as other sensors. Thus, the cradle 70 can both serve as a primary locator for securing the position of the integrated circuit 400 within the tubular housing 12 as well as the vibration isolation.

As shown in FIG. 10, the cradle 70 can define ribs 412 that extend radially outwardly from a recessed outer surface 414 of the cradle and engage an inner surface 416 of the tubular housing 12. The cradle 70 can further comprise locating features 418 that extend radially outwardly for receipt into corresponding receptacles (e.g., openings 420) of the tubular housing 12.

It is contemplated that the ribs 412 can compress to allow the cradle to shift relative to the tubular housing 12 to isolate the integrated circuit 400 from vibration. Further, it is contemplated that, by supporting the integrated circuit 400 at the edges via the grooves 408 and the projections 410, the integrated circuit 400 can move within the cradle 70 to further isolate the integrated circuit 400 from vibration.

Optionally, the alignment device 10 can comprise at least one indicator 50, such as, for example, an audible indicator (e.g., speaker) or visual indicator (e.g., LED, display, etc.). The indicator 50 can provide an audible and/or visual indication to an operator corresponding to the orientation of the alignment device. For example, in some aspects, the indicator can be a display that outputs orientation data, such as, for example, azimuth and angles relative to horizontal axes.

In some aspects, the alignment device 10 can receive a user input (e.g., an alignment setting or desired orientation) from an operator. For example, as shown in FIG. 3, the wireless transmitter 32 can be a transceiver that is in communication with the remote computing device 1001. The remote computing device can provide the desired orientation to the alignment device 10 via the transceiver. In some aspects, the desired orientation can comprise, or be embodied as, a desired azimuthal angle. The computing device 40 can be configured to compare the orientation of the alignment device 10 to the desired orientation. For example, the computing device 40 can calculate a difference between the desired azimuthal angle and a current orientation of the alignment device 10.

In some aspects, the indicator 50 can be configured to provide an indication of the difference between the desired azimuthal angle and the current orientation of the alignment device 10, this difference being referred to herein as the “azimuthal offset.” In some optional aspects, the indicator can comprise an LED that changes color based on the proximity between the desired azimuthal angle and the current orientation of the alignment device 10. For example, green light (from the LED) can indicate an azimuthal offset of within +/−1 degree, yellow light can indicate an azimuthal offset within +/−10 degrees, and red light can indicate an azimuthal offset of greater than +/−10 degrees. As another example, an LED can be configured to flash at a frequency that changes based on the azimuthal offset (e.g., a flash frequency that increases as the azimuthal offset decreases). In various other aspects, the indicator can be a speaker, and the speaker can output a tone that changes frequency and/or volume based on the azimuthal offset or output a voice stating the azimuthal offset. In further aspects, it is contemplated that multiple types of the above-described indicator outputs can be provided concurrently (for example, a visual and audible indicator output can be provided concurrently).

In further aspects, the alignment device can comprise a battery 60 or other power source that can be configured to provide power to the gyroscopic orientation sensor 30, the wireless transmitter 32, computing device 40, and/or indicator 50 (and any other components of the alignment device that require power).

### Exemplary Methods of Use

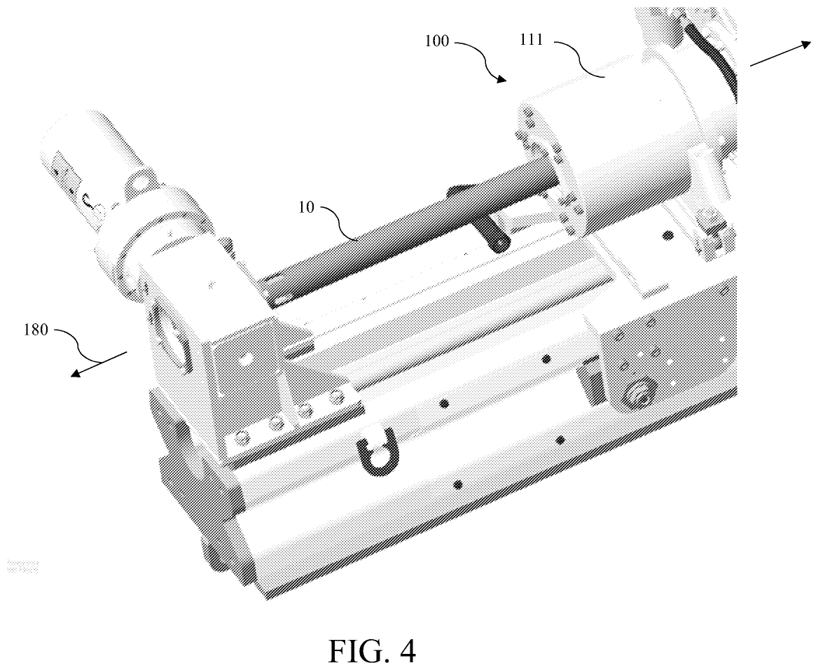

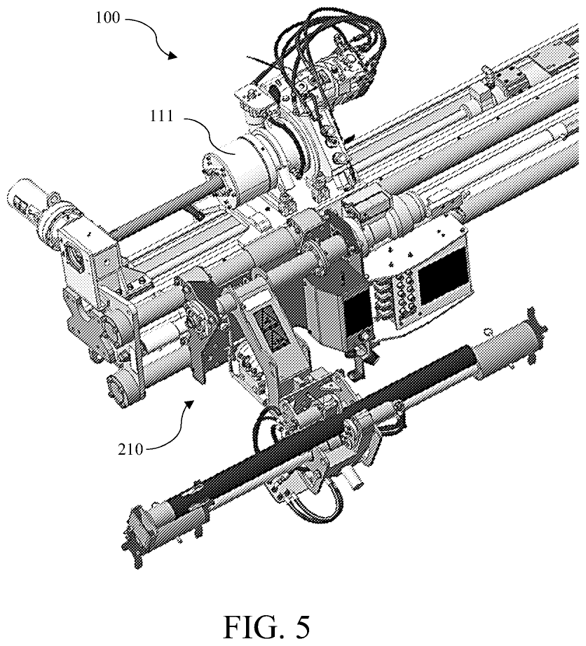

In some aspects, the alignment device 10 can be gripped in a drill string component gripping assembly of a drill rig 100 as further disclosed herein. The drill string gripping assembly can be, for example, and with reference to FIGS. 4-5, a chuck 111 (e.g., of an underground drill rig) or a foot clamp (e.g., of a surface drill rig). Thus, rather than employing a separate mounting assembly or fastener for securing the alignment device to a drill rig or drill rod, the disclosed alignment device can be directly gripped by the standard chuck components of the drill rig, thereby ensuring that the alignment device 10 is in alignment with the drilling axis. Additionally, the compatibility of disclosed alignment device with the drill rig chuck can allow for automated and/or hands-free manipulation of the alignment device in the same manner of drill string components as further disclosed herein.

In use, an operator can adjust the orientation of the drill rig based on orientation data from the alignment device. Optionally, as shown in FIG. 5, the drill rig can comprise a rod handler 210, and the rod handler can position the alignment device 10 within the chuck (or other drill string component gripping assembly) prior to gripping the alignment device with the chuck. In this way, an operator can be remote from the drill rig.

The chuck 111 can be moved axially along the length of the drilling axis. This can be advantageous when aligning the rig at horizontal to measure changes in the gravity tool face (GTF) and to evaluate the rig for level and/or for twist. As can be understood, GTF can refer to the angular distance of the rotation unit adjustment line with respect to the line passing through the axis of the tool and the high-side tool face. Varying GTF or azimuth along the length of the drilling axis can be associated with a physical issue with the drill rig, such as, for example, a twisted mast or worn guides.

Optionally, the chuck 111 can be moved along the length of the drilling axis when the drilling axis is horizontal or generally horizontal (e.g., within fifteen degrees of horizontal, within ten degrees of horizontal, or within five degrees of horizontal). In this configuration, azimuth can be determined with the drill rig in the lowest possible center of gravity. Further, with the drilling axis oriented horizontally, azimuth can be determined with a high accuracy. In some aspects, after determining azimuth with the drilling axis generally horizontal, the drill rig can subsequently be repositioned (e.g., raised) into position for drilling along a desired drilling path. With the drill rig properly leveled, the azimuth can remain the same as the measured azimuth in the subsequently repositioned orientation. In some aspects, the alignment device 10 can be used to recheck the alignment once in the subsequently repositioned orientation.

In some aspects, the chuck 111 can rotate the alignment device 180 degrees about the drilling axis. It is contemplated that inherent error of the gyroscopic orientation sensor 30 can be canceled out by collection of data in two orientations offset by 180 degrees. In this way, the alignment device can provide orientation data with greater accuracy.

### Exemplary Drill Rig

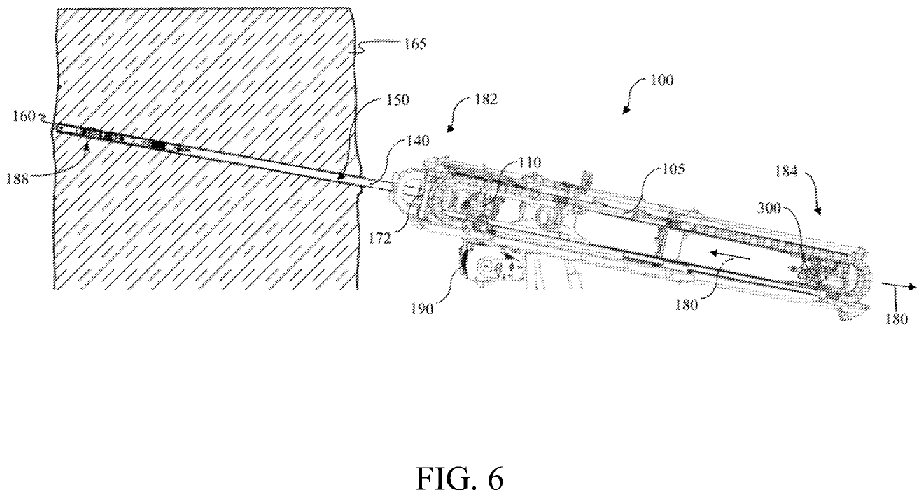

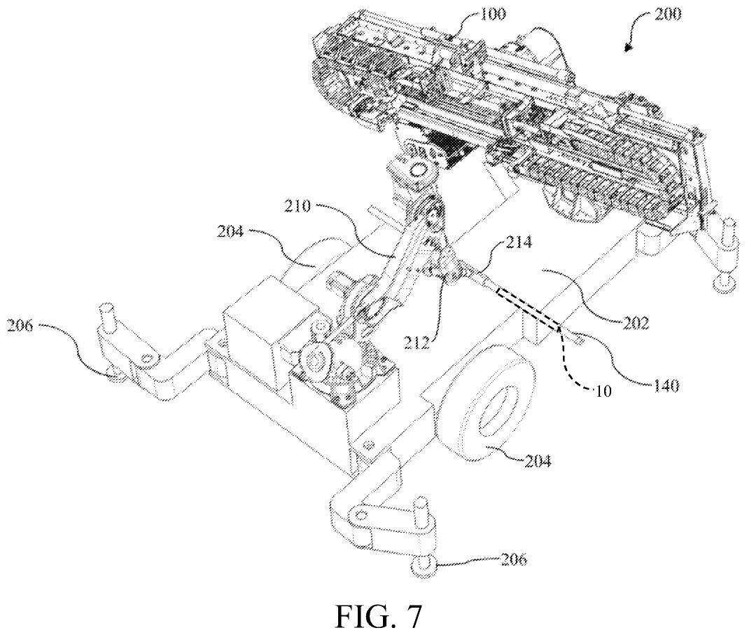

Disclosed herein, in various aspects and with reference to FIGS. 6-7, is an exemplary drill rig 100 that can use the alignment device 10 (FIG. 1). Optionally, in exemplary applications, the drill rig 100 can be used in underground drilling operations. An exemplary drill rig configuration is described below; however, it is contemplated that any conventional underground drill rig configuration can be used. In exemplary aspects, the drill rig 100 can comprise a feedframe 105 and a first head assembly 110 that is movable on the feedframe 105. The first head assembly 110 can be configured to grip drill rods 140 and casings. The first head assembly 110 can comprise a conventional chuck drive rotation unit (or chuck 111) as is known in the art. One drill rod 140 can be threadedly coupled to additional drill rods 140 to create a drill string 150. In turn, the drill string 150 can be coupled to a drill bit 160 or other in-hole tool configured to interface with the material to be drilled, such as a formation 165 (e.g., an underground formation, such as a rock formation). A core tube assembly 188 (i.e., a core barrel assembly) can be disposed at a distal end of the drill string 150 to receive the material to be drilled (e.g., a core sample).

The feedframe 105 can be oriented such that the drill string 150 is generally horizontal, or oriented upwardly relative to the horizontal, or oriented downwardly relative to the horizontal. The drill rig 100 can thus have a longitudinal drilling axis 180 extending between a front portion 182 and a rear portion 184 of the drill rig 100. Further, the first head assembly 110 is configured to rotate the drill string 150 during a drilling process. In particular, the first head assembly 110 may vary the speed at which the drill string 150 rotates as well as the direction of rotation. The rotational rate of the drill head and/or the torque the first head assembly 110 transmits to the drill string 150 may be selected as desired according to the drilling process. At the front portion 182, the drill rig can comprise a rod holder 172, or foot clamp, that is configured to grip the drill string 150. The drill rig 100 can further comprise a wireline winch 190 that can be used to retract a wireline cable in a conventional manner. Optionally, in use, the wireline cable can be coupled to an overshot to permit retrieval of the overshot. According to at least one aspect, the overshot can be pumped down to engage the core tube assembly 188, and the wireline winch 190 can retract the overshot with the core tube assembly 188 attached thereto. In this way, the drilling system can be used to retrieve core samples. Optionally, the rig 100 can comprise a second head assembly 300 that can be used to couple drill rods to the drill string and provide drilling fluid therethrough.

Referring also to FIG. 7, a drilling system 200 can include the drill rig 100 and a support platform 202, which can optionally include wheels 204 and at least one jack 206 (optionally, a plurality of jacks). Optionally, a rod handler 210 can couple to the platform 202. The rod handler 210 can comprise a moveable arm 212 (e.g., a robotic arm) and a pair of jaws 214 that are coupled to the moveable arm and configured to selectively grab the drill rods 140 to feed to, and remove from, the drill rig 100. In further embodiments, the rod handler 210 can employ switchable magnets (e.g., electromagnets) to selectively grip and release the drill rods 140. In exemplary aspects, the rod handler can have a controller that is operatively coupled to the moveable arm and the pair of jaws. In these aspects, the controller of the rod handler can be communicatively coupled (e.g., via wireless communication) with a computing device, such as a tablet, smartphone, or computer, which can provide control instructions to the controller of the rod handler. Optionally, it is contemplated that the same computing device that controls the rod handler can also receive the output signals from the alignment device. Alternatively, it is contemplated that multiple computing devices can be used.

Optionally, the alignment device 10 can be coupled to a drill rod 140 in axial alignment with said drill rod. For example, the alignment device 10 can be received within the drill rod 140, as shown in FIG. 7. A rod handler 210 (FIG. 7) can be used to position the drill rod within the chuck 111. That is, the alignment device 10 can be held by holding the drill rod. Use of the alignment device can be performed as described herein with the alignment device held by the drill rod. Thus, an operator need not handle the alignment device. In this way, operator interaction, also known as “hands on steel,” can be minimized. In other aspects, the rod handler 210 can grip the alignment device 10 itself to position the alignment device within the chuck 111.

In further aspects, the alignment device 10 can be used for aligning a surface drill rig. Thus, the drill rig 100 can be a surface drill rig having a foot clamp. The alignment device 10 can be gripped by the foot clamp. With the alignment device 10 gripped within the foot clamp, the alignment device can be used to determine azimuth of the drill rig.

In further aspects, the alignment device 10 can be used to measure alignment of a casing. For example, in some optional aspects, the alignment device can be positioned at least partially within a collar of a borehole or otherwise coupled to the casing in axial alignment with said casing. In exemplary aspects, an adapter or other fixture can couple the alignment device 10 to the casing. The adapter can be configured to grip, for example, an interior surface or an outer surface of the casing.

It should be understood that although reference is used to the drill string 150 comprising drill rods 140 throughout this disclosure, various other drill string components (e.g., slip subs) could be included as portions of the drill string 150. Moreover, the drilling system 200 can handle such other drill string components in a similar manner (e.g., gripping, threading onto the drill string 150, and removing from the drill string 150).

### Computing Device

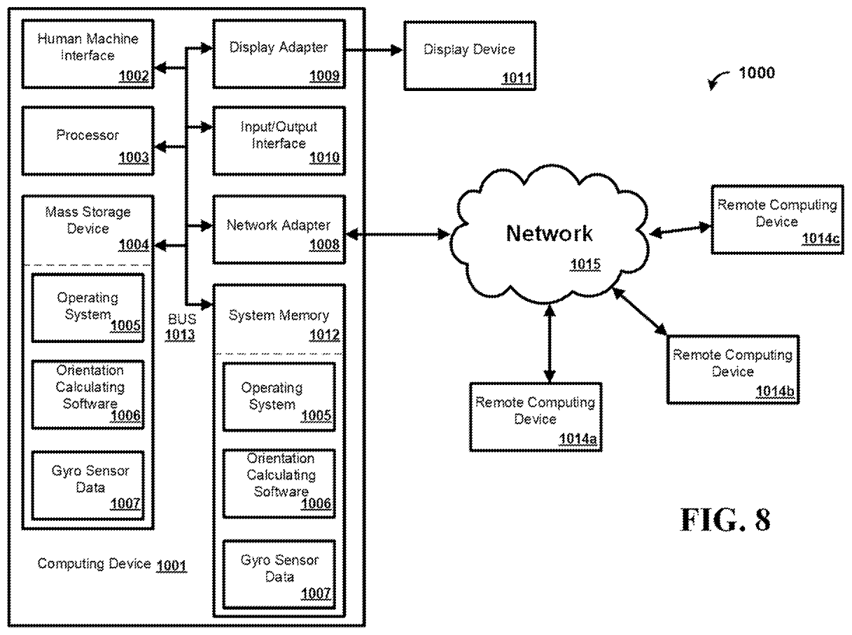

FIG. 8 shows an operating environment 1000 including an exemplary configuration of the computing device 1001. The computing device 1001 may comprise one or more processors 1003, a system memory 1012, and a bus 1013 that couples various components of the computing device 1001, including the one or more processors 1003, to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as gyro sensor data 1007 and/or program modules such as operating system 1005 and orientation calculating software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and orientation calculating software 1006 may be stored on the mass storage device 1004. One or more of the operating system 1005 and orientation calculating software 1006 (or some combination thereof) may comprise program modules and the orientation calculating software 1006. Gyro sensor data 1007 may also be stored on the mass storage device 1004. Gyro sensor data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a microphone, a joystick, a scanner, a touchscreen, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In further optional aspects, the remote computing device 1014b can be a server that receives and stores logged data from the alignment device. In optional aspects, some or all data processing can be performed via cloud computing on a computing device or system that is remote to the computing device 1001.

Application programs and other executable program components such as the operating system 1005 are shown herein as discrete blocks, although it is recognized that such programs and components may reside at various times in different storage components of the computing device 1001, and are executed by the one or more processors 1003 of the computing device 1001. An implementation of orientation calculating software 1006 may be stored on or sent across some form of computer readable media. Any of the disclosed methods may be performed by processor-executable instructions embodied on computer readable media.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: An alignment device for measuring orientation of a drill rig having a drill string component gripping assembly, the device comprising: a tubular housing having an outer surface and defining an inner bore, wherein the tubular housing is configured to be at least partially received within the drill string component gripping assembly of the drill rig; a gyroscopic orientation sensor disposed within the tubular housing, wherein the gyroscopic orientation sensor is configured to provide a signal indicative of an orientation of the alignment device; and a wireless transmitter in communication with the gyroscopic orientation sensor, wherein the wireless transmitter is configured to transmit a wireless output indicative of the orientation of the alignment device.

Aspect 2: The alignment device of aspect 1, wherein the housing defines at least one window that is configured to permit wireless communication therethrough.

Aspect 3: The alignment device of aspect 2, wherein the at least one window comprises a plurality of windows that are circumferentially spaced around the tubular housing.

Aspect 4: The alignment device of any one of the preceding aspects, further comprising an end cap that is configured to seal the gyroscopic orientation sensor within the housing.

Aspect 5: The alignment device of any one of the preceding aspects, further comprising at least one processor that is configured to receive the signal from the sensor and determine, based on the signal, the orientation of the alignment device.

Aspect 6: The alignment device of aspect 5, further comprising an indicator, wherein the processor is further configured to: receive a user input comprising at least one orientation parameter associated with a desired orientation of the drill rig, compare the orientation of the alignment device to the desired orientation, and provide, by the indicator, an output to an operator indicative of a difference between the orientation of the device and the desired orientation.

Aspect 7: The alignment device of aspect 6, wherein the at least one orientation parameter comprises an azimuth.

Aspect 8: The alignment device of aspect 6 or aspect 7, wherein the indicator is a visual indicator, wherein the visual indicator is configured to change a visual output based on a relative proximity of the orientation of the alignment device to the desired orientation.

Aspect 9: The alignment device of aspect 6 or aspect 7, wherein the indicator is an audible indicator, wherein the audible indicator is configured to change an audible output based on a relative proximity of the orientation of the alignment device to the desired orientation.

Aspect 10: The alignment device of any one of the preceding aspects, wherein the outer surface of the tubular housing is cylindrical.

Aspect 11: The alignment device of any one of the preceding aspects, wherein the outer surface of the tubular housing has polygonal cross sections.

Aspect 12: A method of using the alignment device as in any one of the preceding aspects, the method comprising:
gripping the alignment device with a chuck of a drill rig, the drill rig having a drilling axis; and
providing, using the gyroscopic orientation sensor of the alignment device, a signal indicative of an orientation of the alignment device.

Aspect 13: The method of aspect 12, further comprising positioning, using a rod handler, the alignment device within the chuck prior to gripping the alignment device with the chuck.

Aspect 14: The method of aspect 12 or aspect 13, wherein the drill rig has a drilling axis, and wherein the method further comprises moving the chuck axially along the drilling axis.

Aspect 15: The method of any one of aspects 12-14, further comprising rotating, using the chuck, the alignment device about 180 degrees.

Aspect 16: The method of any one of aspects 12-15, wherein gripping the alignment device with the chuck of the drill rig comprises gripping a drill rod with the chuck of the drill rig, wherein the alignment device is positioned within and coupled to the drill rod.

Aspect 17: A method of using the alignment device as in any one of aspects 1-11, the method comprising:
gripping the alignment device with at least one gripping device of a drill rig, the drill rig having a drilling axis; and
providing, using the gyroscopic orientation sensor of the alignment device, a signal indicative of an orientation of the alignment device.

Aspect 18: The method of aspect 17, wherein the at least one gripping device comprises a foot clamp, a chuck, or both.

Aspect 19: A method of using the alignment device as in any one of aspects 1-11, the method comprising:
coupling the alignment device to a casing of a borehole; and
providing, using the gyroscopic orientation sensor of the alignment device, a signal indicative of an orientation of the alignment device.

Aspect 20: A system comprising:
an alignment device as in any one of aspects 1-11; and
a remote computing device in communication with the alignment device.

Although the foregoing invention has been described in some detail by way of illustration and example for purposes of clarity of understanding, certain changes and modifications may be practiced within the scope of the appended claims.

1. An alignment device for measuring orientation of a drill rig having a drill string component gripping assembly, the device comprising:
a tubular housing having an outer surface and defining an inner bore, wherein the tubular housing is configured to be at least partially received within the drill string component gripping assembly of the drill rig;
a gyroscopic orientation sensor disposed within the tubular housing, wherein the gyroscopic orientation sensor is configured to provide a signal indicative of an orientation of the alignment device; and
a wireless transmitter in communication with the gyroscopic orientation sensor, wherein the wireless transmitter is configured to transmit a wireless output indicative of the orientation of the alignment device.

2. The alignment device of claim 1, wherein the housing defines at least one window that is configured to permit wireless communication therethrough.

3. The alignment device of claim 2, wherein the at least one window comprises a plurality of windows that are circumferentially spaced around the tubular housing.

4. The alignment device of claim 1, further comprising an end cap that is configured to seal the gyroscopic orientation sensor within the housing.

5. The alignment device of claim 1, further comprising at least one processor that is configured to receive the signal from the sensor and determine, based on the signal, the orientation of the alignment device.

6. The alignment device of claim 5, further comprising an indicator, wherein the processor is further configured to:
receive a user input comprising at least one orientation parameter associated with a desired orientation of the drill rig,
compare the orientation of the alignment device to the desired orientation, and
provide, by the indicator, an output to an operator indicative of a difference between the orientation of the device and the desired orientation.

7. The alignment device of claim 6, wherein the at least one orientation parameter comprises an azimuth.

8. The alignment device of claim 6, wherein the indicator is a visual indicator, wherein the visual indicator is configured to change a visual output based on a relative proximity of the orientation of the alignment device to the desired orientation.

9. The alignment device of claim 6, wherein the indicator is an audible indicator, wherein the audible indicator is configured to change an audible output based on a relative proximity of the orientation of the alignment device to the desired orientation.

10. The alignment device of claim 1, wherein the outer surface of the tubular housing is cylindrical.

11. The alignment device of claim 1, wherein the outer surface of the tubular housing has polygonal cross sections.

12. A method of using the alignment device as in claim 1, the method comprising:
gripping the alignment device with a chuck of a drill rig, the drill rig having a drilling axis; and
providing, using the gyroscopic orientation sensor of the alignment device, a signal indicative of an orientation of the alignment device.

13. The method of claim 12, further comprising positioning, using a rod handler, the alignment device within the chuck prior to gripping the alignment device with the chuck.

14. The method of claim 12, wherein the drill rig has a drilling axis, and wherein the method further comprises moving the chuck axially along the drilling axis.

15. The method of claim 12, further comprising rotating, using the chuck, the alignment device about 180 degrees.

16. The method of claim 12, wherein gripping the alignment device with the chuck of the drill rig comprises gripping a drill rod with the chuck of the drill rig, wherein the alignment device is positioned within and coupled to the drill rod.

17. A method of using the alignment device as in claim 1, the method comprising:
gripping the alignment device with at least one gripping device of a drill rig, the drill rig having a drilling axis; and
providing, using the gyroscopic orientation sensor of the alignment device, a signal indicative of an orientation of the alignment device.

18. The method of claim 17, wherein the at least one gripping device comprises a foot clamp, a chuck, or both.

19. A method of using the alignment device as in claim 1, the method comprising:
coupling the alignment device to a casing of a borehole; and
providing, using the gyroscopic orientation sensor of the alignment device, a signal indicative of an orientation of the alignment device.

20. A system comprising:
an alignment device as in claim 1; and
a remote computing device in communication with the alignment device.
